(19) United States
(12) Patent Application Publication
(10) Pub. No.: US 2025/0128967 A1
(43) Pub. Date: Apr. 24, 2025

(54) ULTRAVIOLET FLUID STERILIZATION DEVICE

(71) Applicant: HERGY INTERNATIONAL CORP., Taipei City (TW)

(72) Inventors: Chun-Hung LU, Taipei City (TW); Chih-Hsin CHEN, Taipei City (TW)

(21) Appl. No.: 18/381,465

(22) Filed: Oct. 18, 2023

(51) Int. Cl. C02F 1/32

(52) U.S. Cl. CPC C02F 1/325; C02F 2201/3222; C02F 2201/3227; C02F 2201/3228; C02F 2201/328

(57) ABSTRACT

This disclosure is related to an ultraviolet fluid sterilization device. A box includes a chamber, a water inlet and a water outlet. A window is defined on the bottom side of the chamber. A light-transmitting plate is combined to the window to seal the bottom side of the chamber. A lamp holder module includes a lamp holder and an ultraviolet LED set. The lamp holder is detachably combined to the box. The ultraviolet LED set is disposed corresponding to the window. An external fluid flows into the chamber from the water inlet. The light emitted from the ultraviolet LED set enters the chamber from the window to irradiate the external fluid, and then the external fluid flows to outside.

### BACKGROUND OF THE DISCLOSURE

### Technical Field

The technical field relates to an ultraviolet sterilizing device, and more particularly relates to an ultraviolet fluid sterilization device.

### Description of Related Art

A common method of using ultraviolet (UV) lamps (such as an ultraviolet light tube or LEDs) for sterilization in the market is to arrange ultraviolet lamps inside or outside a box and a single flow channel is used to have fluid being irradiated by ultraviolet rays. Therefore, sterilization may be accomplished by irradiating the fluid with ultraviolet rays for a certain time.

Moreover, the LED light in the ultraviolet fluid sterilization device is a crucial component used to generate the required ultraviolet rays. However, the ultraviolet fluid sterilization devices of the related art encounter some issues when it comes to replacing the LED light. For example, the replacement of the LED light often requires draining all the fluid from the chamber. Furthermore, since all the LED lights are integrated into a single module, it is not possible to replace a single malfunctioning LED light, and that results in high maintenance costs.

In view of the above drawbacks, the inventor proposes this disclosure based on his expert knowledge and elaborate researches in order to solve the problems of related art.

### SUMMARY OF THE DISCLOSURE

One object of this disclosure is to provide an ultraviolet fluid sterilization device, in which a window is defined on the box, the lamp holder is detachably combined to the bottom side of the box, and the ultraviolet LED set is disposed corresponding to the window, so that the ultraviolet LED set may be replaced without draining all the fluid in the box.

In the embodiment of this disclosure, an ultraviolet fluid sterilization device includes a box, a light-transmitting plate and a lamp holder module. The box includes a chamber, a water inlet and a water outlet communicating with the chamber. A window is defined on a bottom side of the chamber. The light-transmitting plate is combined to the window to seal the bottom side of the chamber. The lamp holder module includes a lamp holder and an ultraviolet LED set combined in the lamp holder. The lamp holder is detachably combined to the bottom side of the box, and the ultraviolet LED set is disposed corresponding to the window. An external fluid flows into the chamber from the water inlet, and a light emitted from the ultraviolet LED set enters the chamber from the window to irradiate the external fluid, and the external fluid flows to outside from the water outlet.

Another object of this disclosure is to provide an ultraviolet fluid sterilization device, in which the ultraviolet LED set is disposed independently from the control board, and the number and the position of the ultraviolet LED set are corresponding to that of the windows on the bottom side of the box. Therefore, single malfunctioning LED light may be repaired or replaced, and the maintenance costs may be reduced.

In the embodiment of this disclosure, an ultraviolet fluid sterilization device includes a box, a plurality of light-transmitting plates and a lamp holder module. The box includes a chamber, a water inlet and a water outlet communicating with the chamber, and a plurality of windows being defined on a bottom side of the chamber. The light-transmitting plates are combined to each of the windows separately to seal the bottom side of the chamber. The lamp holder module includes a lamp holder, a control board combined in the lamp holder and a plurality of ultraviolet LED sets electrically connected to the control board. The ultraviolet LED sets are disposed independently from the control board, and number and positions of the ultraviolet LED sets are corresponding to that of the windows. An external fluid flows into the chamber from the water inlet, and a light emitted from each of the ultraviolet LED sets enters the chamber from the window to irradiate the external fluid, and the external fluid flows to outside from the water outlet.

In comparison with the related art, the lamp holder module of the ultraviolet fluid sterilization device in this disclosure is detachably combined to the bottom side of the box. Additionally, the light-transmitting plate is combined to the window to seal the bottom side of the chamber. Therefore, since the bottom side of the box is sealed, the lamp holder module may be removed without draining the fluid in the box in advance. The ultraviolet LED set may be replaced without draining all the fluid in the box, so that the maintenance is convenient. Furthermore, the ultraviolet LED set and the control board of the ultraviolet fluid sterilization device in this disclosure are disposed independently, so that each ultraviolet LED set may be individually coupled to the control board. Therefore, repairment or replacement may be performed to individual ultraviolet LED set instead of the entire light source module. Thus, the maintenance is convenient and the maintenance costs is reduced.

### BRIEF DESCRIPTION OF THE DRAWINGS

The features of the disclosure believed to be novel are set forth with particularity in the appended claims. The disclosure itself, however, may be best understood by reference to the following detailed description of the disclosure, which describes a number of exemplary embodiments of the disclosure, taken in conjunction with the accompanying drawings, in which:

FIG. 1 is a cross sectional view of the ultraviolet fluid sterilization device in this disclosure.

FIG. 2 is a combination schematic view of the box and the lamp holder module of the ultraviolet fluid sterilization device in this disclosure.

FIG. 3 is a perspective exploded view of the box of the ultraviolet fluid sterilization device in this disclosure.

FIG. 4 is a perspective exploded view of the lamp holder module of the ultraviolet fluid sterilization device in this disclosure.

FIG. 5 and FIG. 6 illustrate flowing schematic views of the fluid in the ultraviolet fluid sterilization device in this disclosure.

FIG. 7 and FIG. 8 illustrate another embodiment of the ultraviolet LED set of the ultraviolet fluid sterilization device in this disclosure.

### DETAILED DESCRIPTION

The technical contents of this disclosure will become apparent with the detailed description of embodiments accompanied with the illustration of related drawings as follows. It is intended that the embodiments and drawings disclosed herein are to be considered illustrative rather than restrictive.

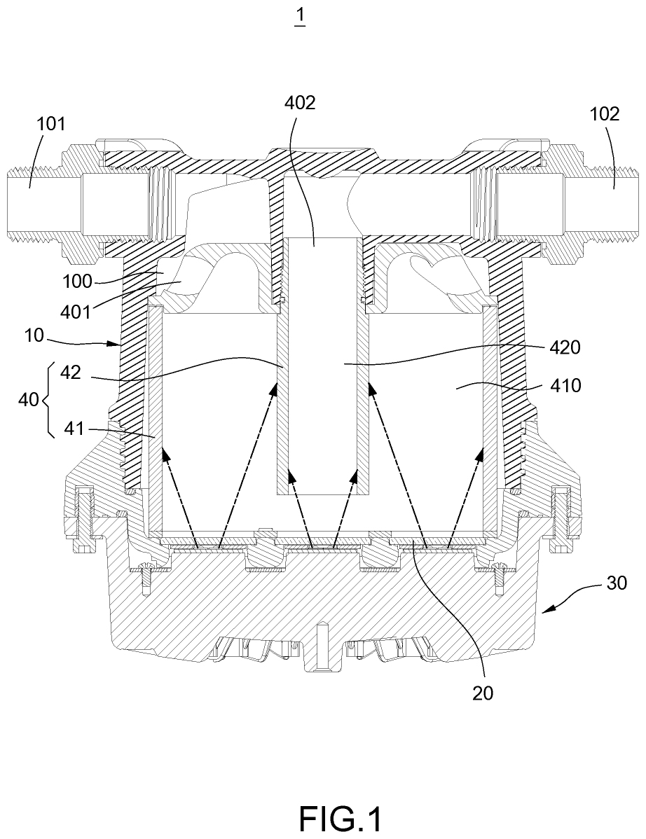

Please refer to FIG. 1, which depicts a cross sectional view of the ultraviolet fluid sterilization device in this disclosure. This disclosure is a fluid sterilization device 1 including a box 10, a light-transmitting plate 20 and a lamp holder module 30. The light-transmitting plate 20 is combined on the inner bottom side of the box 10. The lamp holder module 30 is combined to the outer bottom side of the box 10. Accordingly, the light emitted from the lamp holder module 30 passes through the light-transmitting plate 20 and enters the box 10 to irradiate the fluid inside the box 10 to achieve the effect of ultraviolet sterilization for the fluid.

In this embodiment, the box 10 includes a chamber 100, a water inlet 101 and a water outlet 102 both communicating with the chamber 100. The water inlet 101 and the water outlet 102 are coaxially arranged to facilitate waterway arrangement to increase the convenience of assembly.

Moreover, the ultraviolet fluid sterilization device 1 further includes a water-dividing component 40. The water-dividing component 40 includes a flow inlet 401 and a flow outlet 402. The flow inlet 401 is disposed corresponding to the water inlet 101 to receive the external fluid flowing from the water inlet 101. Additionally, the flow outlet 402 is disposed corresponding to the water outlet 102 to direct the external fluid in the chamber 100 toward the water outlet 102 to flow out. In some embodiments, the flow inlet 401 is an opening with a chamfered surface to facilitate the fluid entering the water-dividing component 40 and flowing spirally in the water-dividing component 40.

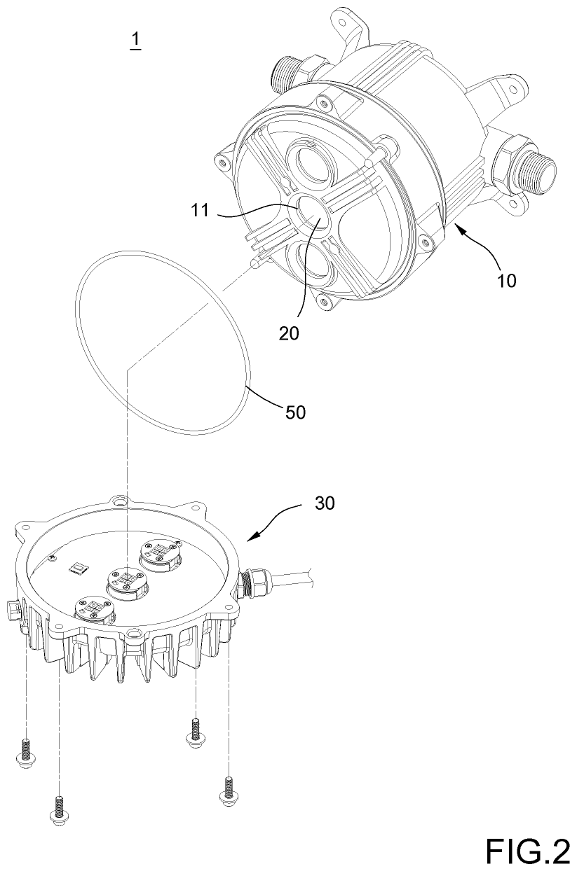

Please refer to FIG. 2, which is a combination schematic view of the box and the lamp holder module of the ultraviolet fluid sterilization device in this disclosure. In this embodiment, the lamp holder module 30 is detachably combined to the bottom side of the box 10. Furthermore, the light-transmitting plate 20 is combined to the window 11 on the bottom side of the box 10 to seal the bottom side of the chamber 100.

In one embodiment of thus disclosure, the ultraviolet fluid sterilization device 1 further includes a sealing ring 50. The sealing ring 50 is sandwiched between the box 10 and the lamp holder module 30 to prevent moisture from entering the box 10 to ensure the airtightness of the lamp holder module 30.

It should be noted that the box 10 and the lamp holder module 30 respectively are independent components. When the light source of the lamp holder module 30 is damaged or requires maintenance, the lamp holder module 30 may directly be disassembled for repair. Furthermore, since the bottom side of the box 10 is sealed, the fluid in the box 10 does not need to be drained out in advance when the lamp holder module 30 is disassembled, so that the maintenance is convenient.

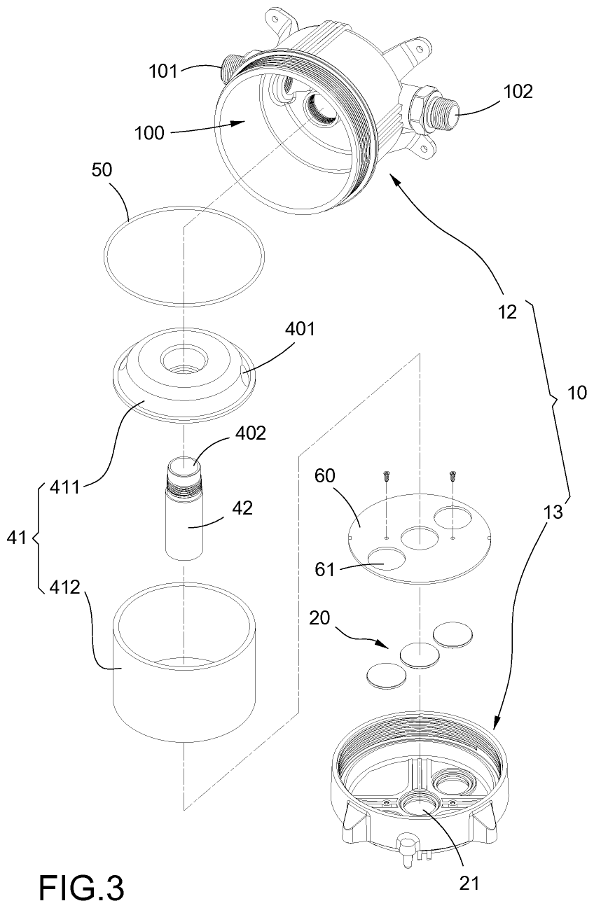

Please further refer to FIG. 3, which is a perspective exploded view of the ultraviolet fluid sterilization device in this disclosure. The box 10 of the ultraviolet fluid sterilization device 1 includes a chamber 100. The water inlet 101 and the water outlet 102 communicate to the chamber 100. Furthermore, a plurality of windows 11 are defined on the bottom side of the box 10. A plurality of light-transmitting plates 20 are arranged corresponding to the windows 11 and are separately combined to the windows 11 through silicone adhesive to seal the bottom side of the chamber 100. It should be noted that each light-transmitting plate 20 of this disclosure is disposed corresponding to each window 11 to disperse the pressure of the fluid acting on the light-transmitting plate 20 to prevent the light-transmitting plate 20 from being damaged due to fluid pressure.

In this embodiment, the box 10 includes a shell 12 and a base 13. The shell 12 includes the water inlet 101 and the water outlet 102. The window 11 is defined on the base 13. The base 13 is screwed to the bottom of the shell 12. The shell 12 covers the base 13 to configure the chamber 100.

Moreover, the water-dividing component 40 is disposed in the box 10 to configure single flow channel to make the fluid be irradiated by ultraviolet rays for a certain time to achieve the effect of sterilization. The water-dividing component 40 includes an outer cylinder 41 and an inner cylinder 42 combined in the outer cylinder 41. The outer cylinder 41 includes the flow inlet 401. Multiple flow inlets 401 may be disposed to increase flow rate and flow speed of fluid. Moreover, the inner cylinder 42 is combined in the outer cylinder 41 and includes the flow outlet 402. In some embodiments, the water-dividing component 40 (includes the outer cylinder 41 and the inner cylinder 42) are in a cylindrical shape.

In one embodiment of this disclosure, the outer cylinder 41 includes an upper lid 411 and a hollow column 412. The upper lid 411 covers the hollow column 412 to configure the outer cylinder 41. The inner cylinder 42 is inserted in the flow inlet 401 of the upper lid 411 to configure an outer cavity 410 and an inner cavity 420 communicating with each other (refer to FIG. 1).

It is worth noticing that reflective surfaces are respectively disposed on the inner wall surface of the outer cylinder 41, the inner wall surface of the inner cylinder 42 and the outer wall surface of the inner cylinder 42 for reflecting ultraviolet rays, thereby increasing the effect of ultraviolet sterilization.

In this embodiment, the ultraviolet fluid sterilization device 1 further includes a reflecting plate 60 arranged on the bottom of the chamber 100. A hollow portion 61 is defined corresponding to the position of the light-transmitting plate 30. The reflecting plate 60 is disposed to reflect ultraviolet rays entering the chamber 100 to enhance the effect of sterilization.

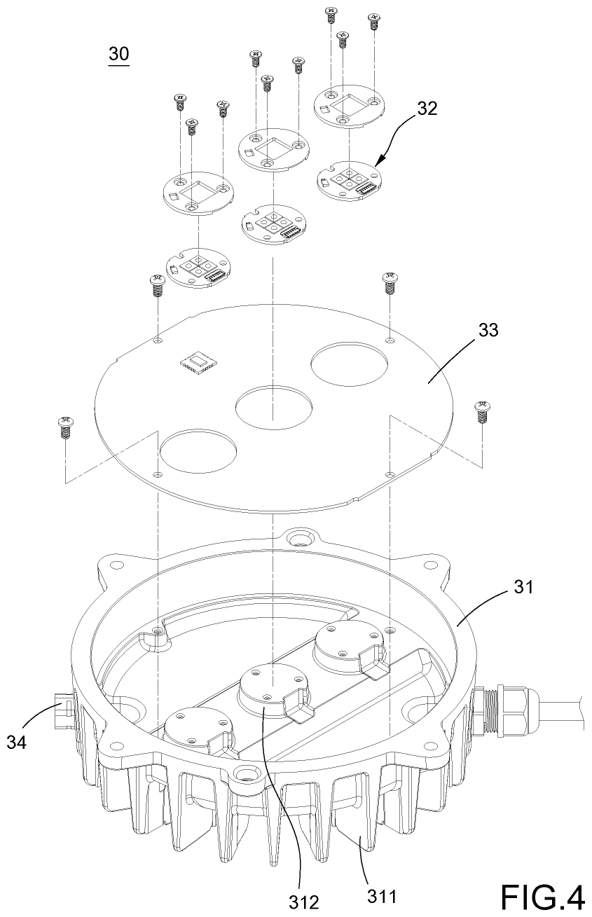

Please refer to FIG. 4, which is a perspective exploded view of the lamp holder module of the ultraviolet fluid sterilization device in this disclosure. The lamp holder module 30 of the ultraviolet fluid sterilization device 1 includes a lamp holder 31 and an ultraviolet LED set 32 combined in the lamp holder 31. The lamp holder 31 is detachably combined to the bottom side of the box 10. The ultraviolet LED set 32 is disposed corresponding to the window 11. Therefore, the light emitted from the ultraviolet LED set 32 passes through the corresponding window 11 and enters the outer cavity 410 and the inner cavity 420 (refer to FIG. 1).

In this embodiment, the lamp holder module 30 further includes a control board 33. Moreover, the ultraviolet LED set 32 is electrically connected to the control board 33 and is disposed independently from the control board 33. The number and the position of the ultraviolet LED set 32 are corresponding to that of the window 11 of the box 10. Accordingly, each ultraviolet LED set 32 may be individually coupled to the control board 33.

Moreover, the lamp holder module 30 further includes an exhaust valve 34. The exhaust valve 34 is arranged on one side of the lamp holder 31 and communicates with the outside. The exhaust valve 34 is disposed to discharge moisture inside the lamp holder 31 to prevent electrical components from being damaged by moisture.

It is worth of noticing that a plurality of heat dissipation fins 311 are arranged spacedly on the lamp holder 31. The lamp holder 31 includes a plurality of thermal bumps 312 located corresponding to the positions of the ultraviolet LED sets 32. The heat generated by the ultraviolet LED sets 32 may be conducted to the lamp holder 31 through the thermal bumps 312 and then dissipated through the heat dissipation fins 311.

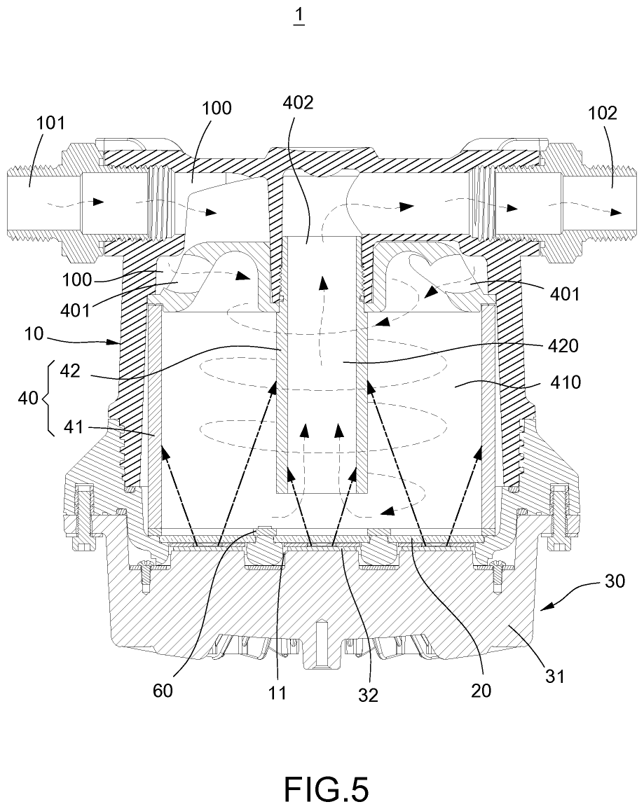

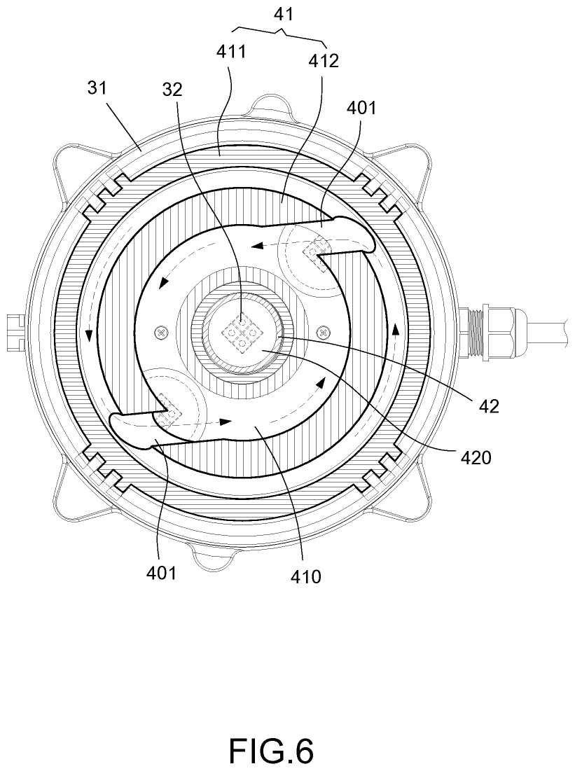

Please further refer to FIG. 5 and FIG. 6, which illustrate flowing schematic views of the fluid in the ultraviolet fluid sterilization device in this disclosure. When the ultraviolet fluid sterilization device 1 of this disclosure is in use, an external fluid flows into the chamber 100 of the box 10 from the water inlet 101, and then enters the outer cavity 410 of the water-dividing component 40 from the flow inlet 401. Furthermore, the external fluid flows spirally in the outer cavity 410 and enters the inner cavity 420. Then, the ultraviolet rays emitted from the ultraviolet LED sets 32 irradiate the fluid in the outer cavity 410 and the inner cavity 420. Subsequently, the external fluid in the inner cavity 420 is pushed by the fluid behind and flows toward the flow outlet 402. Finally, the external fluid flows out from the water outlet 102.

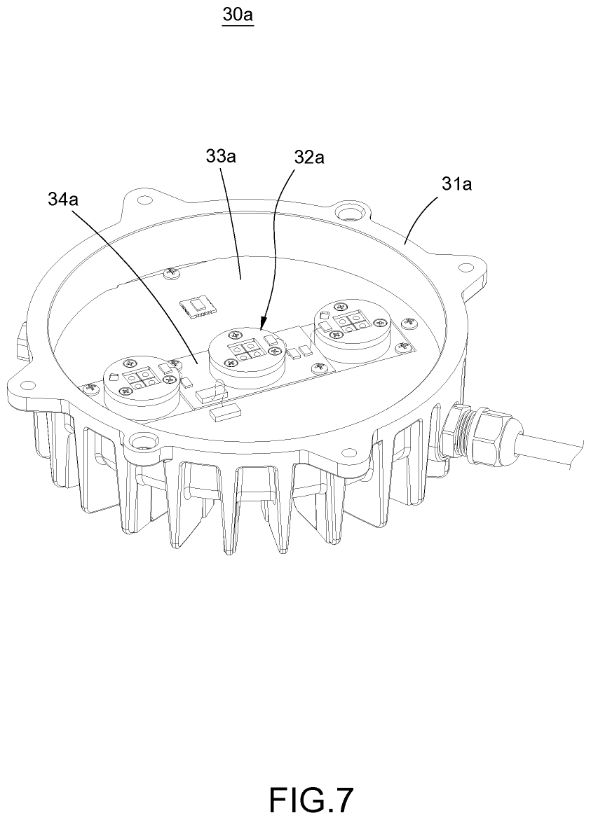

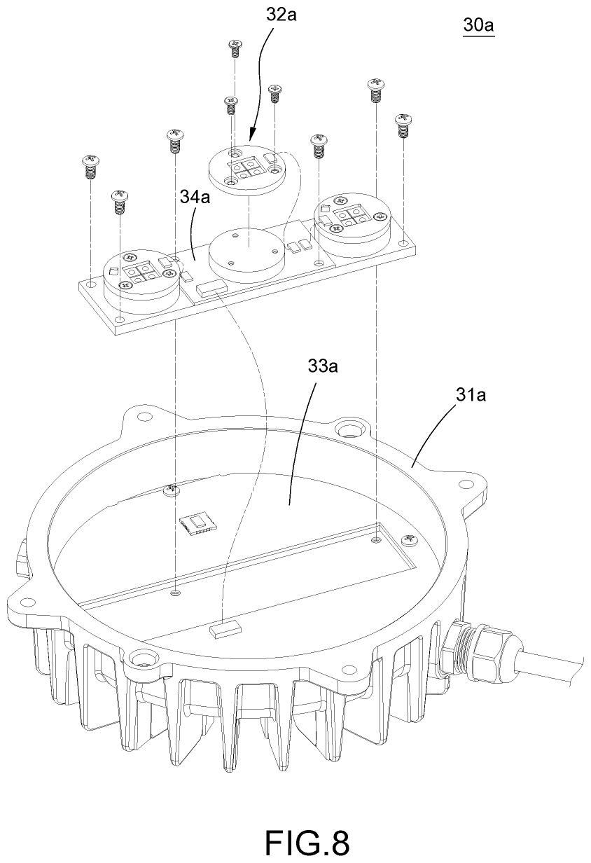

Please refer to FIG. 7 and FIG. 8, which illustrate another embodiment of the ultraviolet fluid sterilization device in this disclosure. In the embodiment, a lamp holder module 30a includes a lamp holder 31a, a plurality of ultraviolet LED sets 32 combined in the lamp holder 31a, and a control board 33a. The difference of this embodiment is that the lamp holder module 30a further includes a driving circuit board 34a. The driving circuit board 34a is electrically connected to each ultraviolet LED set 32a and the control board 33a. The ultraviolet LED sets 32a are combined in the lamp holder 31a through the driving circuit board 34a. When the ultraviolet LED set 32a needs maintenance, the lamp holder 31a may be removed out the lamp holder 31a individually without disassembling the control board 33a, so that the maintenance is convenient.

While this disclosure has been described by means of specific embodiments, numerous modifications and variations could be made thereto by those skilled in the art without departing from the scope and spirit of this disclosure set forth in the claims.

What is claimed is:

1. An ultraviolet fluid sterilization device, comprising:
a box, comprising a chamber, a water inlet and a water outlet both communicating with the chamber, and a window defined on a bottom side of the chamber;
a light-transmitting plate, combined to the window to seal the bottom side of the chamber; and
a lamp holder module, comprising a lamp holder and an ultraviolet LED set combined in the lamp holder, wherein the lamp holder is detachably combined to the bottom side of the box, and the ultraviolet LED set is disposed corresponding to the window;
wherein, an external fluid flows into the chamber from the water inlet, and a light emitted from the ultraviolet LED set enters the chamber from the window to irradiate the external fluid, and the external fluid flows to outside from the water outlet.

2. The ultraviolet fluid sterilization device according to claim 1, further comprising a water-dividing component disposed in the chamber, wherein the water-dividing component comprises a flow inlet and a flow outlet, the flow inlet is disposed corresponding to the water inlet to receive the external fluid flowing from the water inlet, and the flow outlet is disposed corresponding to the water outlet to direct the external fluid in the chamber toward the water outlet to flow out.

3. The ultraviolet fluid sterilization device according to claim 2, wherein the water-dividing component comprises an outer cylinder and an inner cylinder combined in the outer cylinder, the outer cylinder comprises the flow inlet, and the inner cylinder is combined in the flow outlet.

4. The ultraviolet fluid sterilization device according to claim 3, wherein the outer cylinder comprises an upper lid and a hollow column, the outer cylinder is structured in a manner of the upper lid covering the hollow column, and an outer cavity and an inner cavity communicating with each other are structured in a manner of the inner cylinder being inserted in the flow inlet of the upper lid.

5. The ultraviolet fluid sterilization device according to claim 3, wherein an inner wall surface of the outer cylinder, an inner wall surface of the inner cylinder and an outer wall surface of the inner cylinder are all reflective surfaces.

6. The ultraviolet fluid sterilization device according to claim 1, wherein the lamp holder module further comprises a control board, the ultraviolet LED set is electrically connected to the control board, and a number and a position of the ultraviolet LED set are corresponding to that of the window of the box.

7. The ultraviolet fluid sterilization device according to claim 1, further comprising a reflecting plate arranged on a bottom of the chamber, and a hollow portion is defined on the reflecting plate and located corresponding to a position of the light-transmitting plate.

8. An ultraviolet fluid sterilization device, comprising:
a box, comprising a chamber, a water inlet and a water outlet communicating with the chamber, and a plurality of windows defined on a bottom side of the chamber;
a plurality of light-transmitting plates, combined to the windows separately to seal the bottom side of the chamber; and
a lamp holder module, comprising a lamp holder, a control board combined in the lamp holder and a plurality of ultraviolet LED sets electrically connected to the control board, wherein the ultraviolet LED sets are disposed independently from the control board, and number and positions of the ultraviolet LED sets are corresponding to that of the windows;
wherein, an external fluid flows into the chamber from the water inlet, and a light emitted from each of the ultraviolet LED sets enters the chamber from the window to irradiate the external fluid, and the external fluid flows to outside from the water outlet.

9. The ultraviolet fluid sterilization device according to claim 8, further comprising a water-dividing component disposed in the chamber, wherein the water-dividing component comprises a flow inlet and a flow outlet, the flow inlet is disposed corresponding to the water inlet to receive the external fluid flowing from the water inlet, and the flow outlet is disposed corresponding to the water outlet to direct the external fluid in the chamber toward the water outlet to flow out.

10. The ultraviolet fluid sterilization device according to claim 9, wherein the water-dividing component comprises an outer cylinder and an inner cylinder combined in the outer cylinder, the outer cylinder comprises the flow inlet, and the inner cylinder is combined in the flow outlet.

11. The ultraviolet fluid sterilization device according to claim 10, wherein the outer cylinder comprises an upper lid and a hollow column, the outer cylinder is structured in a manner of the upper lid covering the hollow column, and an outer cavity and an inner cavity communicating with each other are structured in a manner of the inner cylinder being inserted in the flow inlet of the upper lid.

12. The ultraviolet fluid sterilization device according to claim 10, wherein an inner wall surface of the outer cylinder, an inner wall surface of the inner cylinder and an outer wall surface of the inner cylinder are all reflective surfaces.

13. The ultraviolet fluid sterilization device according to claim 8, further comprising a reflecting plate arranged on a bottom of the chamber, and a hollow portion is defined on the reflecting plate and located corresponding to a position of the light-transmitting plate.
